(19) United States
(12) Patent Application Publication
(10) Pub. No.: US 2005/0246584 A1
(43) Pub. Date: Nov. 3, 2005

(54) Test data managing system and method

(75) Inventor: Yi-Hong Jiang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/952,692

(22) Filed: Sep. 29, 2004

(30) Foreign Application Priority Data
Apr. 16, 2004 (TW) 93110623

(51) Int. Cl. G06F 11/00

(52) U.S. Cl. 714/25

(57) ABSTRACT

A test data managing system includes testing machines (10), an application server (11), a test data database (13), and a shop flow control database (14). The application server includes a receiving module (110) for receiving serial numbers of testing machines and products, and for receiving test results; a querying module (111) for querying a testing sequence, and a serial number of a next testing machine; a determining module (112) for determining whether a testing machine is a designated next testing machine; an updating module (113) for updating serial numbers of a last testing machine and the next testing machine; a format converting module (114) for converting the test results into designated data format files; a transmitting module (115) for transmitting the designated data format files to the shop flow control database; and a data deleting module (116) for deleting the designated data format files from the test data database.

### BACKGROUND OF THE INVENTION

1. Field of the Invention

The present invention relates to data processing systems and methods, and particularly to a system and method for managing data on testing of products such as computer main boards.

2. Related Art of the Invention

A main board is one of the most important components of a typical personal computer. The main board supports various electronic components thereon, such as resistors, capacitors, integrated circuits, chipsets and connectors. The quality of the main board is heavily dependent on the reliability and compatibility of the components thereof.

Quality control of main boards by manufacturers involves implementing reliability and compatibility tests before the main boards are dispatched out from the factory. It is customary practice in the main board industry to conduct an in-circuit test or a functional test on newly manufactured main boards. In the in-circuit testing process, the soldering quality of a printed circuit board assembly produced through a surface mounting process and the quality of each circuit component in a selected group of components are tested in order to detect defects. Such defects include, for example, the components being shorted or incorrectly attached onto the printed circuit board. In this process, non-functioning components can be readily identified, and repaired or replaced. Since each defective part can be readily identified and repaired or replaced where necessary, the entire printed circuit board need not be discarded when a defect is detected. In the functional testing process, an output performance of an electronic circuit based on the application of a known predetermined input signal can be measured.

During the above testing processes, a great deal of test data is generated and updated in a short time. It is conventional to depend on manual operations to collect the test data. The test data enable an operator to acquire and analyze information on the quality of the main boards. The operator can then arrange for corresponding measurement criteria on the relevant production lines to be adjusted accordingly, in order to properly control the quality of the main boards.

Conventionally, the above test data collecting process is dependent on manual operations to collect the test data in real time, because the test data is constantly updated. As each piece of test data on newly manufactured main boards is generated, further manual operations are needed accordingly. Moreover, in general, manual operations inevitably involve human error and lead to mistakes in the test data collecting process. Accordingly, there is a need for a new system and method for efficiently collecting test data during newly manufactured main board testing processes, and for efficiently transferring the test data to a shop flow control system for controlling of relevant production lines.

### SUMMARY OF THE INIVENTION

A main objective of the present invention is to provide a test data managing system and method, which can automatically collect and transfer test data during testing of newly manufactured products in real time.

To accomplish the above objective, a test data managing system in accordance with a preferred embodiment of the present invention comprises a plurality of testing machines, an application server, a test data database, and a shop flow control database. The application server is connected to the testing machines via a communication network, and is connected to the test data database and the shop flow control database via a connection. Each of the testing machines conducts a particular test on a newly manufactured product. Various tests conducted comprise an open circuit test, a closed circuit test, and an interface compatibility test. The application server comprises a plurality of modules for managing test data stored in the test data database. The test data comprise information on each testing machine and each product, and test results for each product. Information on a testing machine includes a serial number of the testing machine, and a type of test that can be done by the testing machine. Information on a product includes a serial number of the product, a corresponding testing sequence, a serial number of a last testing machine visited, and a serial number of a next testing machine to be visited. The testing sequence is a test route in which the product is tested by the testing machines one by one, and is stored in the test data database. The shop flow control database is for receiving and storing the test results to support operators to control relative production lines.

The application server comprises a receiving module, a querying module, a determining module, an updating module, a format converting module, a transmitting module, and a data deleting module. The receiving module is used for receiving serial numbers of the testing machines and products, and for receiving test results from the testing machines. The querying module is used for querying a testing sequence of a product to be tested, a serial number of a last testing machine and a serial number of next testing machine in the test data database, according to a serial number of the product to be tested. The determining module is used for determining whether a testing machine on which the product is currently located is the next testing machine specified in the corresponding testing sequence. The updating machine is used for updating the serial numbers of the last testing machine and the next testing machine stored in the test data database, when testing of the product by each testing machine has been completed. The format converting module is used for converting the test results into a designated data format file that can be identified by a computer, and storing the designated data format file in the test data database. The transmitting module is used for transmitting the designated data format file to the shop flow control database. The data deleting module is used for deleting the designated data format file that have been transmitted to the shop flow control database from the test data database.

Further, the present invention provides a test data managing method, the method comprising the steps of: (a) receiving a serial number of a testing machine at which a product to be tested is located, and a serial number of the product; (b) querying a corresponding testing sequence, a serial number of a last testing machine and a serial number of a next testing machine, according to the serial number of the product; (c) determining whether the testing machine at which the product is located is the same as the next testing machine; (d) notifying corresponding operators to manually put the product on the correct testing machine, if the testing machine is not the same as the next testing machine,; (e) conducting a test on the product if the testing machine is the same as the next testing machine, and updating the serial numbers of the last testing machine and the next testing machine; (f) receiving test results from the relevant testing machine; (g) converting the test results into a designated data format file, and storing the designated data format file in a test data database; (h) transmitting the designated data format file to a shop flow control database; and (i) deleting the designated data format file from the test data database.

Other objects, advantages and novel features of the present invention will be drawn from the following detailed description with reference to the attached drawings, in which:

### BRIEF DESCRIPRTION OF THE DRAWINGS

FIG. 1 is a schematic diagram of hardware infrastructure of a test data managing system in accordance with the preferred embodiment of the present invention;

FIG. 2 is a schematic diagram of main function modules of an application server of the system of FIG. 1; and

FIG. 3 is a flowchart of a preferred method for managing test data according to the present invention.

### DETAILED DESCRIPTION OF THE INVENTION

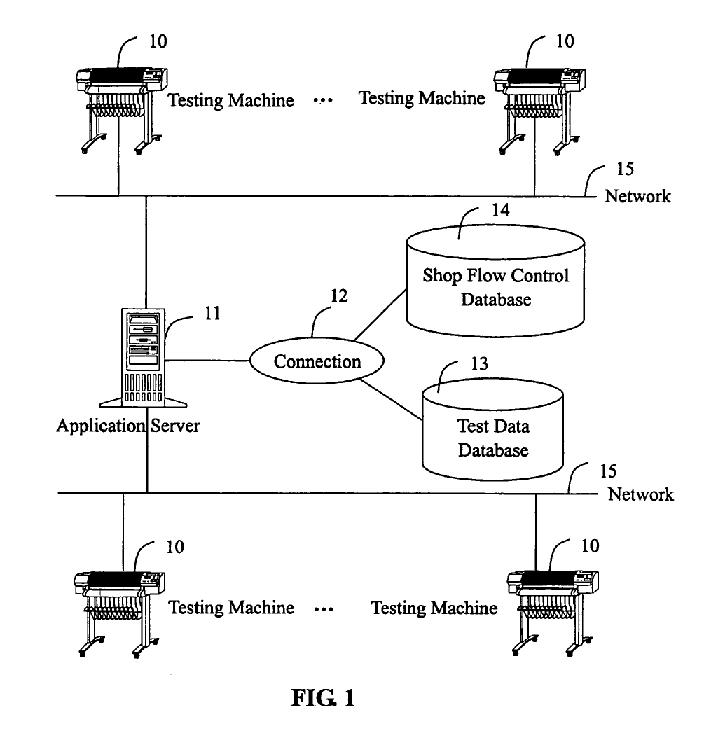

FIG. 1 is a schematic diagram of hardware infrastructure of a test data managing system (hereinafter, “the system”) in accordance with the preferred embodiment of the present invention. The system comprises a plurality of testing machines 10, an application server 11, a connection 12, a test data database 13, a shop flow control database 14, and a communication network 15. The testing machines 10 are connected to the application server 11 via the network 15. The application server 11 is connected to the test data database 13 and the shop flow control database 14 via the connection 12.

The testing machines 10 respectively conduct a particular test on each of newly manufactured products. In the preferred embodiment, the products are computer main boards. The test comprises an open circuit test, a closed circuit test, and an interface compatibility test. The main board passes through all the testing machines 10 according to a preset testing sequence, for the purpose of quality control of different parts of the main board. The preset testing sequence is a test route in which the main board is tested by the testing machines 10 one by one, and is stored in the test database 13. The application server 11 comprises a plurality of modules for managing test data generated during tests, and transmitting corresponding designated data format files to the shop flow control database 14. The test data comprise information on each testing machine 10 and each main board, and test results for each main board. Information on a testing machine 10 includes a serial number of the testing machine 10, and a type of test that can be done by the testing machine 10. Information on a main board includes a serial number of the main board, a corresponding testing sequence, and serial numbers of the last testing machine 10 visited and the next testing machine 10 to be visited. The last testing machine 10 is the particular testing machine 10 on which the main board has just been tested. The next testing machine 10 is the testing machine 10 on which the main board is to be tested following testing on the last testing machine 10, according to the testing sequence. Thus the serial numbers of the last testing machine 10 and the next testing machine 10 change when each test on the main board by each testing machine 10 has been completed. The shop flow control database 14 receives and stores the designated data format files from the test data database 13, in order to support operators to control relative production lines. The network 15 may be an intranet, the Internet, or any other suitable type of communications network. The connection 12 is a database connectivity such as an ODBC (Open Database Connectivity) or a JDBC (Java Database Connectivity).

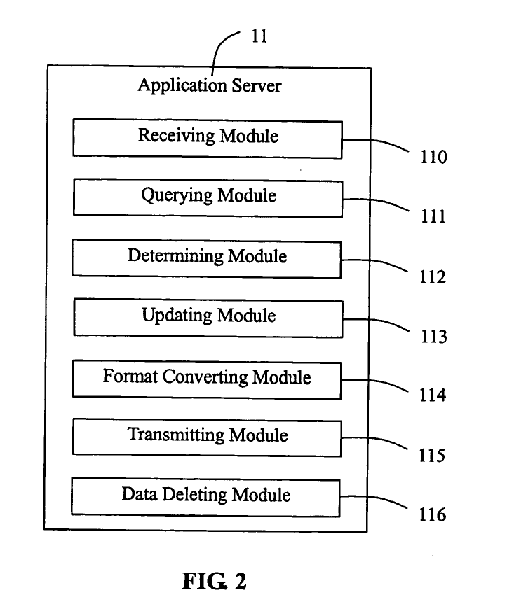

FIG. 2 is a schematic diagram of main function modules of the application server 11. The application server 11 comprises a receiving module 110, a querying module 111, a determining module 112, an updating module 113, a format converting module 114, a transmitting module 115, and a data deleting module 116. The receiving module 110 receives serial numbers of the testing machines 10 and main boards, and receives test results from the testing machines 10. The querying module 111 queries a testing sequence of a main board to be tested, and serial numbers of the last testing machine 10 and the next testing machine 10, in the test data database 13. This querying is done according to a serial number of the main board to be tested. The determining module 112 determines whether a testing machine 10 on which the main board is currently located is the next testing machine 10 specified in the testing sequence. The updating module 113 updates the serial numbers of the last testing machine 10 and the next testing machine 10 stored in the test data database 13, when testing of the main board by each testing machine 10 has been completed. The format converting module 114 converts test results into a designated data format file that can be identified by a computer, and stores the designated data format file in the test data database 13. The designated data format file may be an Oracle database data format file, or an SQL (Structured Query Language) database data format file. The transmitting module 115 transmits the designated data format files from the test data database 13 to the shop flow control database 14. The data deleting module 116 deletes the designated data format files that have been transmitted to the shop flow control database 14 from the test data database 13. In general, this is done in order to reduce occupied storage space. Furthermore, in the case where the test results received from the testing machines 10 are the same as previous test results still stored in the test data database 13 occurring the same mother board is tested again, the received test results are mere duplications, and deletion of the received test results does not materially alter the data already stored in the test data database 13.

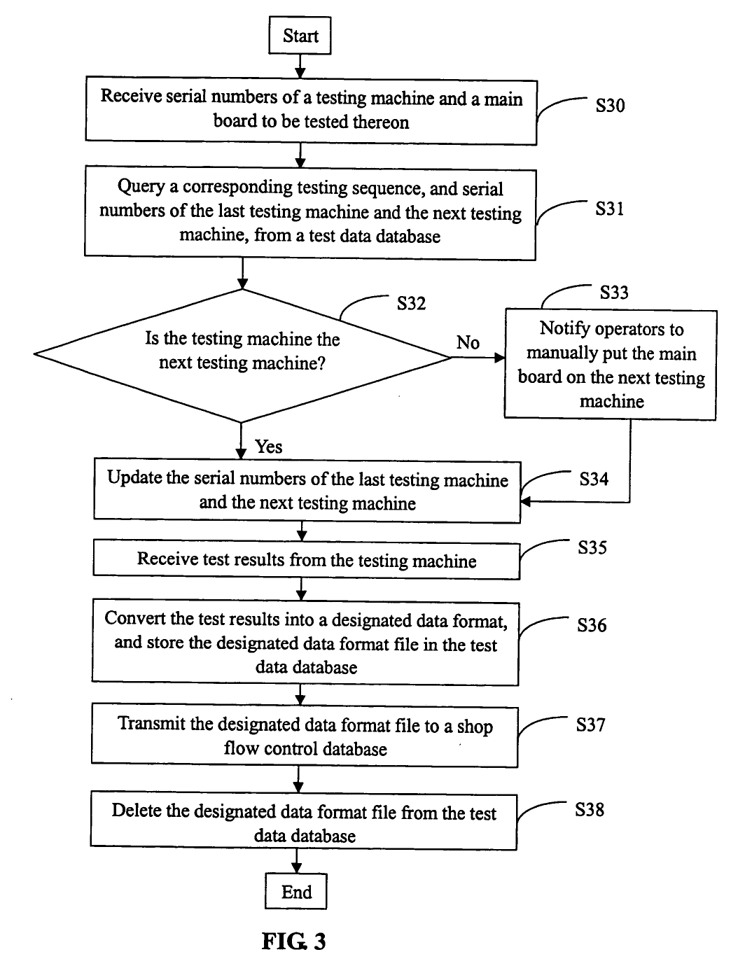

FIG. 3 is a flowchart of a preferred method for managing test data of a product according to the present invention. In the preferred method, the product is a computer main board. In step S30, the receiving module 110 receives a serial number of a testing machine 10 on which the main board to be tested is currently located, and a serial number of the main board. In step S31, the querying module 111 queries a corresponding testing sequence, and serial numbers of the last testing machine 10 and the next testing machine 10, from the test data database 13. This is done according to the serial number of the main board. In step S32, the determining module 112 determines whether a testing machine 10 on which the main board is currently located is the same as the next testing machine 10, by comparing the serial numbers of the two testing machines 10. If the testing machine 10 on which the main board is currently located is the same as the next testing machine 10, the procedure goes directly to step S34 described below. If the testing machine 10 on which the main board is currently located is not the same as the next testing machine 10, in step S33, the determining module 112 notifies corresponding operators to manually put the main board on the correct testing machine 10, whereupon the procedure goes to step S34.

In step S34, the testing machine 10 on which the main board is currently located conducts a particular test on the main board. Then the updating module 113 updates the serial numbers of the last testing machine 10 and the next testing machine 10. In step S35, the receiving module 110 receives the results of said particular test from the relevant testing machine 10. In step S36, the format converting module 114 converts the test results into a designated data format file, and stores the designated data format file in the test data database 13. In step S37, the transmitting module 115 transmits the designated data format file to the shop flow control database 14. In step S38, the data deleting module 116 deletes the designated data format file from the test data database 13.

Although the present invention has been specifically described on the basis of a preferred embodiment and preferred method, the invention is not to be construed as being limited thereto. Various changes and modifications may be made to the embodiment and method without departing from the scope and spirit of the invention.

1. A test data managing system, comprising:
one or more testing machines, each of the testing machines conducting a particular test on newly manufactured products;
a test data database;
a shop flow control database; and
an application server, which is connected to the testing machines via a network, and which is connected to the test data database and the shop flow control database via a connection, and which comprises:
a receiving module for receiving serial numbers of the testing machines and the products, and receiving test results from the testing machines;
a querying module for querying a testing sequence, a serial number of a last testing machine and a serial number of a next testing machine in the test data database, according to a serial number of a product to be tested;
a determining module for determining whether a testing machine on which the product is currently located is the next testing machine specified in the testing sequence;
an updating module for updating the serial number of the last testing machine and the serial number of the next testing machine stored in the test data database when testing of the product by the testing machine has been completed;
a format converting module for converting results of the testing into designated data format files and storing the designated data format files in the test data database;
a transmitting module for transmitting the designated data format files to the shop flow control database; and
a data deleting module for deleting the designated data format files from the test data database.

2. The test data managing system according to claim 1, wherein the products are computer main boards.

3. The test data managing system according to claim 1, wherein the testing machines can conduct an open circuit test, a closed circuit test, and an interface compatibility test.

4. The test data managing system according to claim 1, wherein the testing sequence is a test route in which each of the products is tested by the testing machines one by one.

5. The test data managing system according to claim 1, wherein the test data database stores serial numbers of the testing machines, types of tests that can be done by the testing machines, serial numbers of the products, testing sequences, and test results.

6. The test data managing system according to claim 1, wherein the shop flow control database stores the designated data format files to support operators to control production lines.

7. A test data managing method, the method comprising the steps of:
receiving a serial number of a testing machine at which a product to be tested is located, and a serial number of the product;
querying a corresponding testing sequence, a serial number of a lasting testing machine and a serial number of a next testing machine from a test data database, according to the serial number of the product;
determining whether the testing machine on which the product is located is the same as the next testing machine;
conducting a test on the product if the testing machine on which the product is located is the same as the next testing machine, and updating the serial numbers of the last testing machine and the next testing machine;
receiving test results from the relevant testing machine;
converting the test results into designated data format files, and storing the designated data format files in the test data database;
transmitting the designated data format files to a shop flow control database; and
deleting the designated data format files from the test data database.

8. The method according to claim 7, further comprising the step of: notifying one or more operators to manually put the product on the correct testing machine when the testing machine on which the product is located is not the same as the next testing machine.

9. The method according to claim 7, wherein the designated data format file is a database data format file.

10. The method according to claim 9, wherein the database data format file is an Oracle database data format file.

11. The method according to claim 9, wherein the database data format file is an SQL (Structured Query Language) database data format file.

12. A test data managing method comprising the steps of:
identifying a current serial number of a testing machine and a current serial number of a product tested by said test machine;
acquiring test data from said testing machine to a test data database in case of said current serial number of said test machine and said current serial number of said tested product in compliance with a previously saved serial number of testing machines including said testing machine and a previously saved serial number of tested products including said tested product from said test data database;
removing said test data out of said test data database;
replacing said previously saved serial numbers with said current serial numbers in said test data database; and
repeating all of the above steps based on information in said test data database.

13. The method according to claim 12, further comprising the step of converting said test data to a predetermined format before acquisition in said test data database.

14. The method according to claim 12, wherein said test data is forwarded to a shop flow control database in said removing step.
